(19) United States
(12) Patent Application Publication
(10) Pub. No.: US 2004/0103031 A1
(43) Pub. Date: May 27, 2004

(54) System and method for electronically locating items

(76) Inventor: Henry Weinschenk, Charlottesville, VA (US)

Correspondence Address: Parker & DeStefano, Suite 300, 300 Preston Avenue, Charlottesville, VA, 22902, US

(21) Appl. No.: 10/641,912

(22) Filed: Aug. 15, 2003

Related U.S. Application Data
(60) Provisional application No. 60/404,026, filed on Aug. 15, 2002.

(51) Int. Cl. G08B 5/22

(52) U.S. Cl. 705/14; 340/825.49; 235/383; 705/28; 345/855

(57) ABSTRACT

A computerized item location system including a kiosk with a computer, keyboard and monitor, connected to an external computer or standing alone, to allow customers to quickly, and accurately, locate items in a store through a full graphic display of the store's floor plan and a perspective view of the item's location. The system may also be used at facilities such as libraries, commercial or industrial warehouses, airports, malls, tourist districts, and trade shows. In addition, the computerized kiosk system allows management personnel to find out important information about customers' requests, including products currently out of stock or not stocked. The kiosk system may perform alone with a single computer or, in larger stores, may be connected to auxiliary kiosks throughout the store.

The present invention is directed generally to a computerized system for obtaining item information, and specifically to a computerized kiosk system for use in facilities such as stores, libraries, and tourist areas to assist persons in locating desired items.

### BACKGROUND OF THE INVENTION

Finding particular items in a store or a congested or unfamiliar area, especially a supermarket or other large store, can sometimes be challenging. This is especially true when the customer is new to the store, is purchasing an unusual item, or is away from home. Many grocery stores and other large facilities have developed systems of assisting customers such as providing alphabetically listed products on signs suspended from the ceiling and/or printed listings on the end of aisles or on shopping carts.

Recently, some stores have begun using electronic displays incorporated into the shopping carts as disclosed by Begum in U.S. Pat. No. 6,177,880. Begum discloses an electronic display incorporated into a shopping cart handle that allows customers to locate products by category or brand names; however, this system only provides aisle numbers and is limited to about 50 item categories. This is a significant deficiency given that thousands of product categories are stocked in a typical store. Also, the Begum invention inquiries are limited to a scrolling mechanism, since it lacks a means for alphanumerical entries. Further, Begum is applicable only to a grocery store type layout consisting of aisles. If there are no aisle numbers, Begum is ineffective.

### SUMMARY OF THE INVENTION

The present invention is directed to a product locating system that includes a freestanding kiosk or bank of kiosks combining a computer, keyboard, monitor screen, and backlit signage for use in facilities such as grocery stores wherein customers can quickly and accurately locate products, by type or brand. The system uses databases containing information about the products carried and their respective location in the store, commonly known as “Store merchandising floor plan”. The system also uses databases that can provide a variety of other information such as inventory and pricing information. When the customer enters a specific item request into the computer at the kiosk, a floor plan of the store is displayed indicating where the requested product is located and where the customer is presently standing. The monitor also displays where the product is specifically located on the shelf by displaying a perspective illustration of the shelving with its various levels. If the particular product is currently out of stock or is not carried by the store, this information will be provided to the customer. Upon request, the customer can also print out a paper slip with the requested information.

The system can consist of a single kiosk, or in larger stores, multiple kiosks located in different parts of the store or as a bank of kiosks, or as a combination of a bank of kiosks plus others located at remote locations. If multiple kiosks are used, one kiosk will be the master kiosk and the others will be the auxiliary kiosks. In smaller stores all the databases may be incorporated in the master kiosk, while in large stores, principally chain stores, the databases may be queried from a store or chain-wide computer, mainframe, or server.

The advantage of this kiosk system is that it allows shoppers to quickly locate products in a store, with much more detail than the currently available display systems and without having to resort to store personnel.

### BRIEF DESCRIPTION OF DRAWINGS

FIG. 1 is perspective view of the kiosk.

FIG. 1A is perspective view of the kiosk, but with parts broken out to show all major components.

FIG. 2 shows a typical store floor plan, indicating possible locations for various kiosks in the store.

FIG. 3 is a diagram showing the overall layout of the system, including a Master Kiosk, Auxiliary Kiosks, a Store (or Chain) Computer or Server, typical databases and reports.

FIG. 4 shows the Initial Screen displayed in the monitor when not in use by a customer.

FIG. 5 shows the First Selection screen, once the customer starts using the system.

FIG. 6 shows the Initial Database Lookup screen.

FIG. 7 shows the Location Screen, product located on left side of aisle.

FIG. 8 shows the Location Screen with enhanced product information, product located on left side of aisle.

FIG. 9 shows the Location Screen with enhanced product information, product located on right side of aisle.

### DETAILED DESCRIPTION OF THE INVENTION

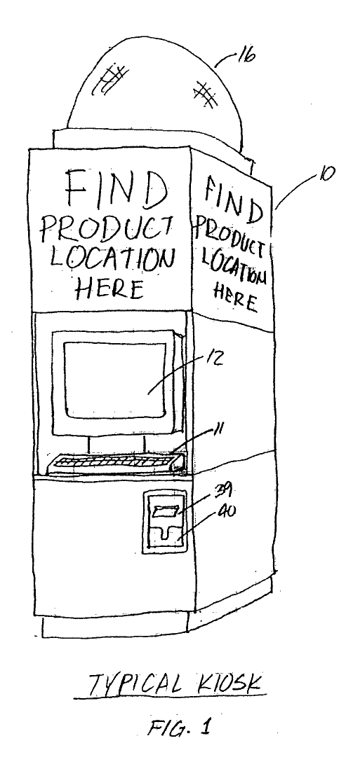

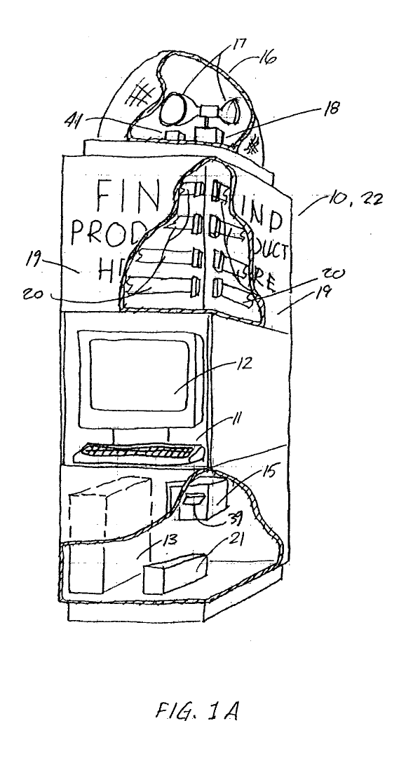

Referring to FIG. 1 and to FIG. 1A, the kiosk computer system 100 of this invention combines the general housing 10 of a kiosk with a keyboard 11, a monitor 12, a general-purpose computer 13, and preferably a printer 15 as the main means of the system to interact with the user. On the front of the housing 10 is located a window 40 to allow access to the paper slips 39 printed by the printer 15. The system 100 also preferably incorporates an uninterruptible power supply (UPS) 21 located near the computer 13.

In addition, the housing 10 can be equipped with backlit signage or other eye-catching display to attract customers' attention consisting of translucent panels 19 and fluorescent tubes 20. Optionally, to call even more attention, the housing 10 can be equipped with a translucent dome light 16, inside which are spotlights 17, rotating inside the dome 16 and powered by an electric motor and reducing gear combination 18. Besides rotating, the spotlights 17 may also be controlled by a flasher device 41.

The kiosk system of the present invention can be customized for use in a variety of locations and facilities. For instance, the kiosk system can be adapted for use in libraries to locate books; warehouses to locate products; airports to locate terminals, restaurants, baggage claim areas, etc.; tourist districts to locate points of interest, restaurants, stores, etc.; trade shows to locate vendors; and malls to locate stores, restaurants, ATM machines, etc. These are only a few examples and in no way limits the scope of the present invention. In addition to location, the kiosk system can be programmed to provide a variety of information to a user such as product availability, prices, menus, hours of operation, and other relevant information related to a facility. For simplicity, this specification mainly refers to use of the kiosk system in a retail store environment; however, this in no way limits the scope of the present invention.

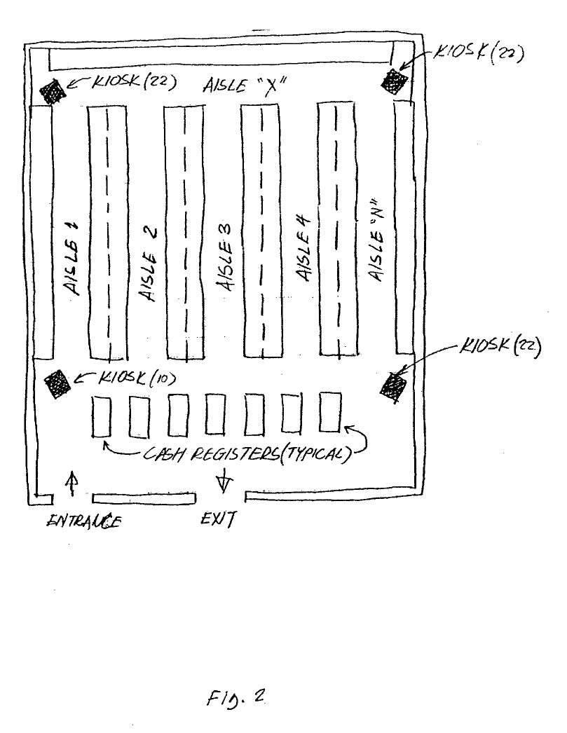

FIG. 2 shows a typical store with a kiosk system 100 operating as a main kiosk 101 and other kiosks operating as auxiliary kiosks 102. Some of the auxiliary kiosks 102 can be located immediately adjacent to the main kiosk 101 as may be preferred, so forming a bank of kiosks. This arrangement is also suitable to other facilities, such as libraries and commercial and industrial warehouses, where items are located on shelves organized along aisles. The kiosk system 100 is preferably located at the entrance to a store, but can be located at any other easily accessible and visible location.

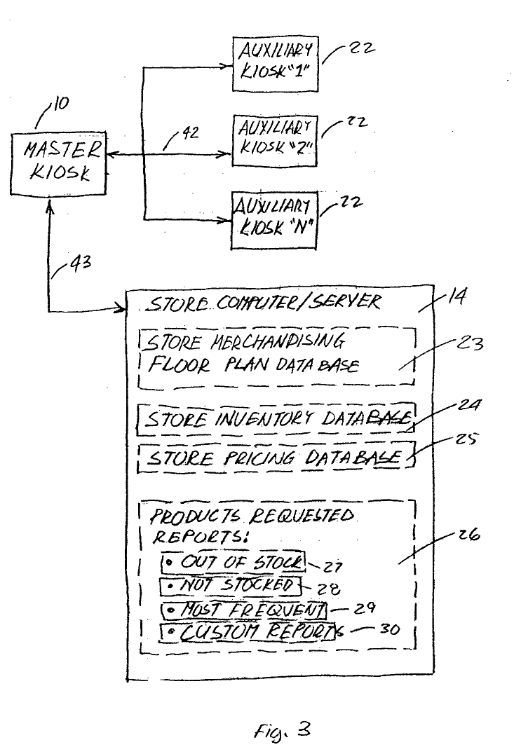

As shown in FIG. 3, when a bank of kiosks is used, the computer 13 of main kiosk 101 is connected through a Local Area Network (LAN) to the computers 13 of auxiliary kiosks 102. The computer 13 at the main kiosk 101 may be connected to a store or facility computer 14 external to the kiosk system by a link 43. This link 43 may also be part of the Local Area Network (LAN), or if the store or facility computer 14 is physically located at a remote location from the store or facility, such as the corporate headquarters of a chain of stores, the link 43 may be established through an Internet or Intranet connection. Further, the computer of kiosk system 100 can be accessible via the Internet, which can be particularly useful to a user searching several stores for a particular item or for out-of-towners trying to locate an item such as a gift, place of interest, etc.

In smaller facilities, the computer 13 of main kiosk 101 can serve as the facility computer 14. The store or facility computer 14, or server, will contain databases that the computer of kiosk system 100 will query regarding such things as the actual location of each item in the store, inventory data, and pricing information. When a user enters a search item into a computer, facility databases will be accessed such as Store Merchandising Floor Plan Database 23, the Store Inventory Database 24, and the Store Pricing Database 25. For the user's view, information about the requested item such as location, availability, and price will be displayed on the monitor 12 at the kiosk. Meanwhile, the kiosk system 100 will provide the store computer 14, or server, with various activity reports viewable by authorized personnel, such as Items Out of Stock 27, Items not Stocked 28, Items Most Frequently Requested 29, and other Custom Reports 30.

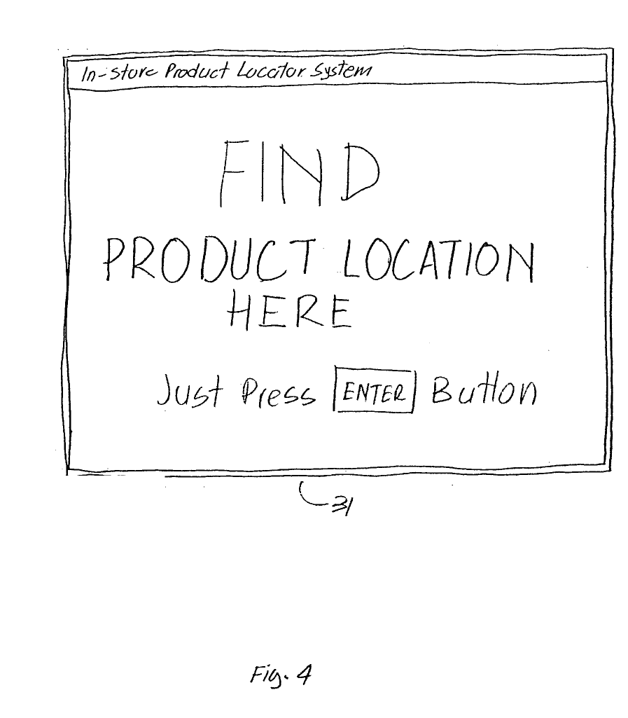

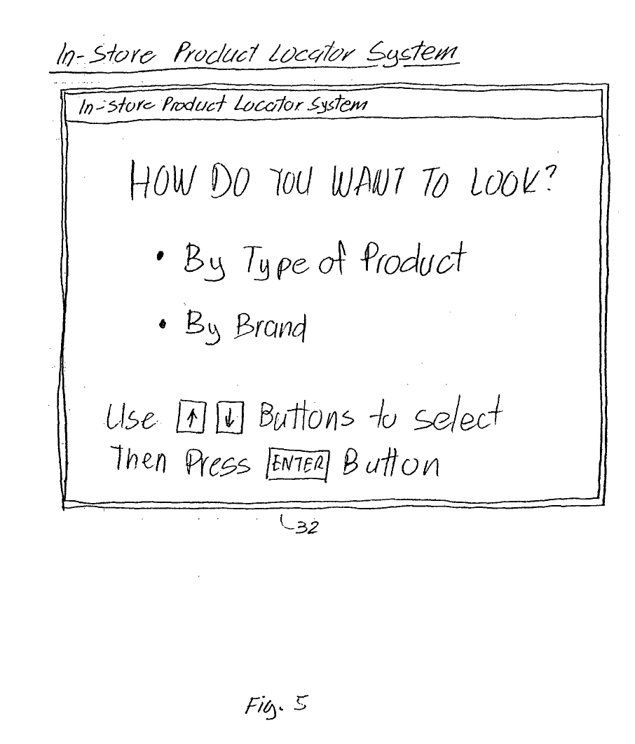

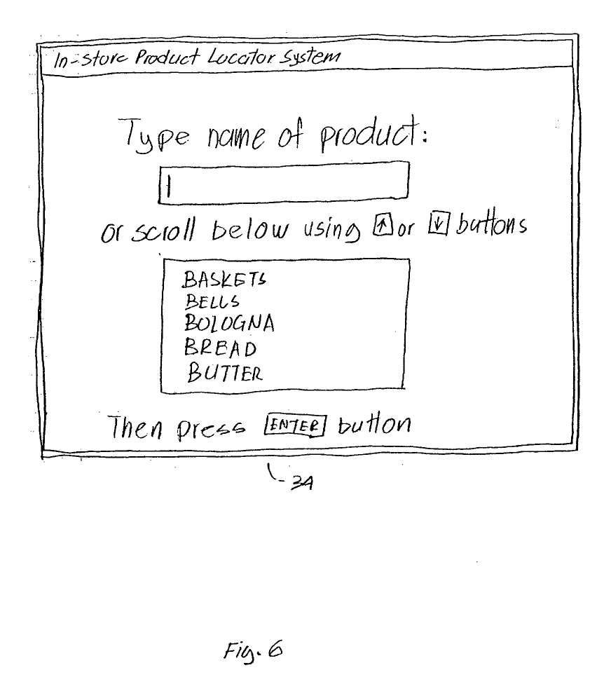

FIG. 4 shows the initial screen 31 as displayed on the kiosk monitor 12, when the kiosk is not in use by a customer. When a customer approaches the kiosk system, the initial screen as shown preferably includes a display indicating that products can be looked up with the computer kiosk system and further instructs the customer how to begin the product search. Once the customer has entered the kiosk system by following instructions displayed on initial screen 31, screen 32 as shown in FIG. 5 appears guiding him or her to select a broad category to search, such as type of product or brand. In the case of libraries the category would be by title or author. Once a category is selected, an initial database look-up screen 34 as shown in FIG. 6 appears, which allows the customer to type in the specific request or to scroll alphabetically through a list using the keyboard. In FIG. 6, the customer chose to query by product name; therefore, the product screen appeared. If a customer chooses to query by brand, a brand screen would appear prompting the customer to enter a particular brand name to scroll through an alphabetical list of brand names. The keyboard of the present invention can be a typical computer keyboard, a touch screen, or any data entry mechanism known in the art. In a preferred embodiment, the computer is equipped with a voice recognition device and speakers that allows the computer to accept and transmit audio commands.

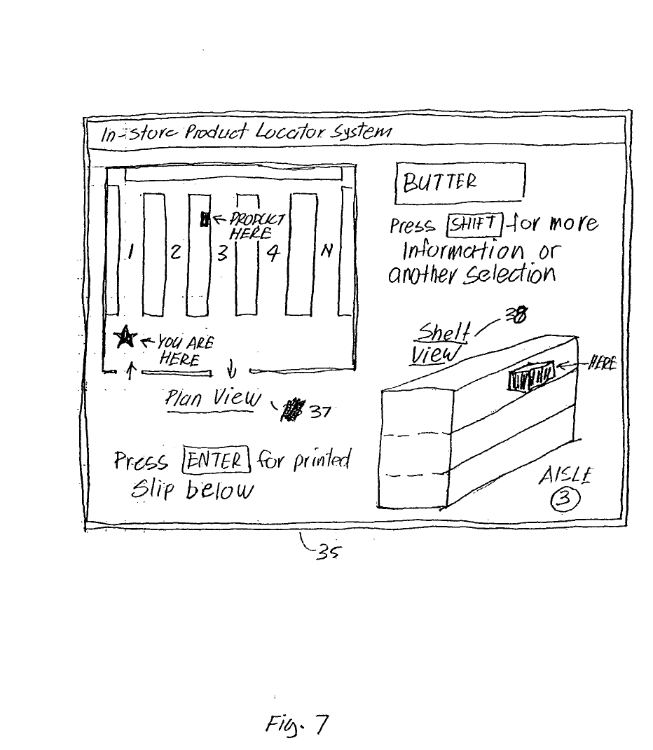

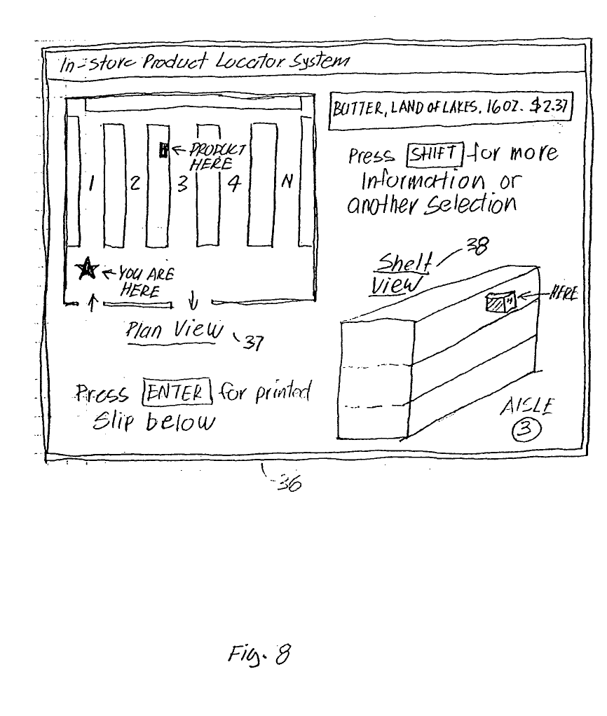

After the query is entered and processed, a results screen 35 as shown in FIG. 7 displays the results of the customer's inquiry. The monitor can display a variety of maps and/or views of the facility, but preferably displays a Plan View 37 of the store, or facility, indicating both the location of the customer and that of the product and a Shelf View 38 showing a perspective view of the shelving clearly indicating the level at which the product is located. FIG. 8 shows a screen 36 when the original inquiry was made by brand.

After a query is complete and displayed on the monitor, a customer can preferably print out the map on a printer attached to that particular kiosk. With the printout in hand, the customer can easily find the desired item. Further, the printer can also be used to print other information relevant to the item such as coupons related to the desired item or a rain check for the sale price of an out of stock item.

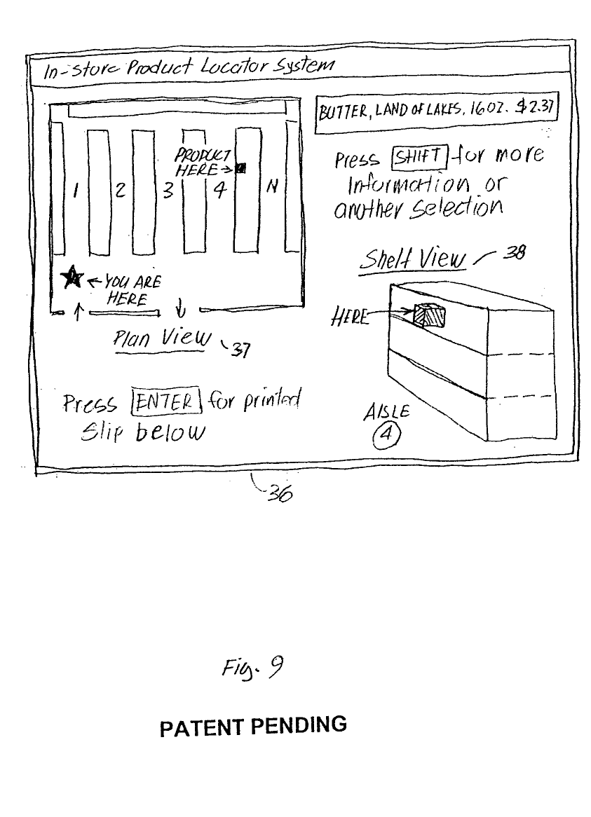

In order to be particularly useful, the system always provides the location of a product in relation to where the customer is currently located within the store, i.e. from the customer's perspective. FIG. 9 illustrates how the Shelf View 38 is sensitive to being located on the right side of the aisle, from where the inquiring customer is located, while FIG. 7 and FIG. 8 illustrate how the Shelf View 38 is sensitive to being located on the left side of the aisle, from where the inquiring customer is located.

A customer can look up several items during one kiosk session. When more than one item is searched, all of the items will appear on one facility map displayed on the screen, and a more detailed map of each item's location can be produced.

While the forgoing embodiments of the present invention have been set forth in considerable detail for the purpose of making a complete disclosure of the invention, it may be apparent to those of skill in the art that numerous changes may be made in such detail without departing from the spirit and principles of the invention.

What is claimed is:

1. A locating system comprising at least one computer, at least one monitor, and at least one keyboard located within a housing unit at a facility, said at least one computer providing to a user information about a location of an item related to said facility by displaying a map of said facility including details of said item location in perspective to said user's position.

2. The locating system of claim 1, wherein said system is stationary.

3. The locating system of claim 1, wherein said facility is a store.

4. The locating system of claim 3, wherein said store is a grocery store.

5. The locating system of claim 1, wherein said facility is a warehouse.

6. The locating system of claim 1, wherein said facility is a library.

7. The locating system of claim 1, wherein said facility is a mall.

8. The locating system of claim 1, wherein said facility is a town tourist district.

9. The locating system of claim 1, wherein said facility is an airport.

10. The locating system of claim 1, wherein said facility is a trade show.

11. The locating system of claim 1, wherein said details comprise aisle location.

12. The locating system of claim 1, wherein said details comprise a shelf view.

13. The locating system of claim 1, wherein said details comprise a shelf level.

14. The locating system of claim 1, wherein said details comprise a hall location.

15. The locating system of claim 1, wherein said details comprise a floor level.

16. The locating system of claim 1, wherein said details include a storefront view.

17. The locating system of claim 1, wherein said details comprise a street location.

18. The locating system of claim 1, wherein said details comprise a building view.

19. The locating system of claim 1, wherein said map is a floor plan.

20. The locating system of claim 1, wherein said at least one computer is a plurality of integrated computers.

21. The locating system of claim 20, wherein said plurality of integrated computers includes a remote computer.

22. The locating system of claim 20, wherein said plurality of integrated computers includes a server.

23. The locating system of claim 20, wherein said integrated plurality of computers includes a master computer and a plurality of auxiliary computers.

24. The locating system of claim 1, wherein said at least one computer stores information requested by a user, wherein said information is accessible by authorized personnel of said facility.

25. The locating system of claim 1, wherein said housing unit is a kiosk.

26. The locating system of claim 1, wherein said housing unit includes a sign mounted to said unit.

27. The locating system of claim 1, wherein said housing unit includes a dome having at least one light mounted within.

28. The locating system of claim 1, further comprising a printer located within said housing unit, said printer dispensing printed information requested by said user related to said item.

29. The locating system of claim 27, wherein said printed information is a map.

30. The locating system of claim 27, wherein said printed information is a coupon.

31. The locating system of claim 27, wherein said printed information is a raincheck.

32. The locating system of claim 1, further comprising a voice recognitions system.

33. The locating system of claim 1, further comprising at least one speaker.

34. The locating system of claim 1 wherein said at least one computer is accessible via the Internet using a remote computer.

35. The locating system of claim 1, wherein said at least one computer is accessible via the Internet using a handheld electronic device.

36. The locating system of claim 1, said at least one computer further providing to a user information about availability of an item.

37. The locating system of claim 1, said at least one computer further providing to a user information about price of an item.

38. The locating system of claim 1, said at least one computer further providing to a user information about brands carried by a facility.

39. The locating system of claim 1, said at least one computer further providing to a user information about hours of operation of a facility.

40. A method of locating an item at a facility using at least one computer comprising:
entering an item name into said computer, wherein said computer obtains information relevant to said item name from a database;
reviewing a map displayed by said computer, said map providing a detailed view of a location of said item; and
following said map to said location.

41. The method of claim 40, wherein said detailed view is a perspective view relative to a user of said computer.

42. A method of claim 39, further comprising printing said map.

43. A method of claim 39, further comprising accessing said at least one computer from a remote location.
